(19) United States
(12) Patent Application Publication
(10) Pub. No.: US 2012/0230594 A1
(43) Pub. Date: Sep. 13, 2012

(54) ADAPTIVE PICTURE ROTATION

(76) Inventors: Jill Boyce, Manalalpan, NJ (US); Stephan Wenger, Hillsborough, CA (US); Danny Hong, New York, NY (US)

(21) Appl. No.: 13/162,074

(22) Filed: Jun. 16, 2011

Related U.S. Application Data
(60) Provisional application No. 61/466,123, filed on Mar. 22, 2011.
(60) Provisional application No. 61/451,303, filed on Mar. 10, 2011.

(51) Int. Cl. G06K 9/36; H04N 7/26

(52) U.S. Cl. 382/232; 375/240.25; 375/240.01; 375/E07.027

(57) ABSTRACT

A method for decoding a picture embedded in a coded video sequence using a reference picture, includes: receiving at least a part of the coded video sequence; decoding the at least a part of the coded video sequence to determine a rotation of the embedded picture; rotating at least a part of the reference picture according to the determined rotation; and using the at least a part of a rotated reference picture to construct a reconstructed picture corresponding to the embedded picture.

### CROSS REFERENCE TO RELATED APPLICATIONS

The application claims the benefit of priority from U.S. Provisional Applications Ser. No. 61/466,123, filed Mar. 22, 2011, and Ser. No. 61/451,303, filed on Mar. 10, 2011, which is hereby incorporated by reference herein in their entirety.

### FIELD

The present application relates to video coding, and more specifically, to the representation of information related to the rotation of a picture relative to its reference picture(s) in a video bitstream, the reaction of a decoder to the information, and the creation and use of the information by an encoder.

### BACKGROUND

Many video compression technologies rely, among others, on inter picture prediction techniques to achieve high compression efficiency. Inter picture prediction allows for the use of information related to a previously decoded (or otherwise processed) picture embedded in a video sequence in the decoding of the current picture of the video sequence. Examples for inter picture prediction mechanisms include motion compensation, where during reconstruction blocks of pixels from a previously decoded picture are copied or otherwise employed after being moved according to a motion vector, or residual coding, where, instead of decoding pixel values, the possibly quantized difference between a (possibly motion compensated) pixel of a reference picture and the reconstructed pixel value is contained in the bitstream and used for reconstruction. Inter picture prediction is the key technology that can enable good coding efficiency in modem video coding.

Some older video compression technologies used only the pixel values of previous (or future) reference pictures for inter picture prediction. Modern video compression techniques, such as ITU-T Rec. H.264 or High Efficiency Video Coding (I-IEVC), which is currently under development in ITU-T Q.6116 and MPEG, can also employ properties of the bitstream that was used for the reconstruction of reference pictures. In H.264, for example, motion vectors from reference pictures(s) can be used in temporal direct mode, to infer the current motion vector. In HEVC, motion vectors from reference pictures can also be required to parse the coded motion vector data. In other words, H.264, HEVC (and possibly other video codecs) can rely on information that is not part of the coded picture currently being processed, and that is not in the form of pixel values. This type of information is henceforth called reference picture meta information, or simply metadata.

Both the HEVC draft at the time of writing and older video compression standards operate on input pictures in a implicitly defined scan order of pixels, which is raster scan order.

By contrast, some current video codecs can change the decoding order of blocks (also known as Coding Units, CUs in HEVC) within a picture. For example, Flexible Macroblock Ordering (FMO) (also known as the slice group concept) in ITU-T Rec. H.264 can be used to modify the ordering of macroblocks in the picture decoding process. Similarly, out of order slices (available in ITU-T Rec. H.263 version 2 Annex K and ITU-T Rec. H.264) or rectangular slices (available in H.263 Annex K) can modify the ordering of macroblocks in the picture decoding process. Neither technology changes the scan order of macroblocks in the context of intra prediction or motion vector prediction, except that some macroblocks may not be available for prediction due to the reordering. In the HEVC context, modified Coding Unit (CU) ordering (in the sense of a modified scan—different than from left to right and from top to bottom) has been proposed in different contexts, for example in U.S. Provisional Patent Application Ser. No. 61/466,123 and entitled “Alternative Block Coding Order In Video Coding”, incorporated by reference herein in its entirety and from which Priority is claimed, or in Kown, Kim, “Frame Coding in vertical raster scan order”, Joint Collaborative Team JCTVC-C224, Guangzhou, October 2010. The latter document mentions pixel based picture rotation in the context of a proof-of-concept study, without further elaborating on details.

Picture rotation in the context of video coding has been disclosed in US Provisional Patent Application 61/451,303 and entitled “Render-Orientation Information In Video Bitstream”, incorporated by reference herein in its entirety and from which priority is claimed.

It is commonly understood that a rotation of source images can occasionally improve the coding efficiency for certain content. In HEVC, specifically, Intra prediction is one coding tool that can benefit from picture rotation, some indication of which can be found in aforementioned JCT-VC-C224.

Three issues remain. First, the encoder should include a mechanism to decide on picture rotation. Second, the possible rotation of an image should be signaled in a bitstream that is part of the normative decoding process, which implies that an encoder should place this information into the bitstream and a decoder should decode and use it. Third, when picture rotation is to be used in the context of inter picture prediction, reference pictures—to be understood here not only as the reference picture pixel data but also including metadata—should be “rotated” in both encoder and decoder.

### SUMMARY

The disclosed subject matter provides for a method to generate and/or use side information, inside a video bitstream, to indicate the rotation of a coded video picture in relation to the format as received from a video encoder's input. It further provides for an encoder that decides on the value of the information, and places it in the bitstream as well as using it for the encoding process, and for a decoder that uses the information for and in its reconstruction process.

In one embodiment there is provided a method for decoding of a picture of a coded video sequence. A rotation information is decoded from the bitstream, and used to rotate at least a part of at least one reference picture. The rotated reference picture(s), or parts thereof, are used for reconstruction.

In the same or another embodiment, the reference picture includes metadata, for example motion vectors that were used for the reconstruction of the reference picture, and that metadata is rotated as well.

In the same or another embodiment at least parts of the reconstructed picture can be stored as (part of a) reference picture, either rotated into the original orientation, or along with information indicating the rotation.

In one embodiment, there is provided a method for encoding. A rotation for at least a part of a picture is determined that can be the best (from a coding efficiency viewpoint) rotation of several rotation candidates. According to this determined rotation, at least a part of the picture is rotated, encoded, and the reconstructed picture (or part thereof is stored as a reference picture.

In the same or another embodiment, the decoding requires information from a reference picture (or part thereof), possibly including metadata, which is rotated.

In one embodiment, a video encoder includes a rotation determination module, a source picture rotation module, a source encoder, and bitstream encoder. The rotation determination module can determine a rotation, for example a rotation that is beneficial for coding efficiency. This rotation can be used to rotate the source picture accordingly, so that, after source and bitstream encoding, a highly coding efficient bitstream is generated.

In the same or another embodiment, the encoder can include a reference picture rotation module, which can receive its rotation information from the rotation determination module and can rotate reference picture(s) or parts thereof so that they can be used for inter picture prediction when coding a rotated source picture.

In the same or another embodiment, the rotation information can be coded and placed into the bitstream, so that a decoder can reverse the rotation.

In one embodiment, a decoder can include a bitstream parser configured to extract at least a rotation information, a reference picture rotation module configured to rotate reference picture(s) or parts thereof according to the rotation information received from the bitstream parser, so to enable inter picture predicted decoding of the bitstream including rotated coded pictures.

In the same or another embodiment, the decoder can further include a reconstructed picture rotation module configured to rotate the reconstructed picture (or parts thereof) so to be able to use the reconstructed picture, in its original orientation, as a reference picture, or for rendering.

In one embodiment, a decoder can include a bitstream parser configured to extract at least a rotation information, a reference picture rotation module, configured to store reference picture(s) or parts thereof for inter picture prediction by the decoder.

### BRIEF DESCRIPTION OF THE DRAWINGS

Further features, the nature, and various advantages of the disclosed subject matter will be more apparent from the following detailed description and the accompanying drawings in which:

FIG. 1 is a schematic illustration of a system in accordance with an embodiment of the present disclosure;

FIG. 2 is a flowchart of an exemplary encoder operation in accordance with an embodiment of the present disclosure;

FIG. 3 is a flowchart of an exemplary rotation determination mechanism for intra coded pictures in accordance with an embodiment of the present disclosure;

FIG. 4 is a flowchart of an exemplary decoder operation in accordance with an embodiment of the present disclosure; and

FIG. 5 shows an exemplary computer system in accordance with an embodiment of the present disclosure.

The Figures are incorporated and constitute part of this disclosure. Throughout the Figures the same reference numerals and characters, unless otherwise stated, are used to denote like features, elements, components or portions of the illustrated embodiments. Moreover, while the disclosed subject matter will now be described in detail with reference to the Figures, it is done so in connection with the illustrative embodiments.

### DETAILED DESCRIPTION

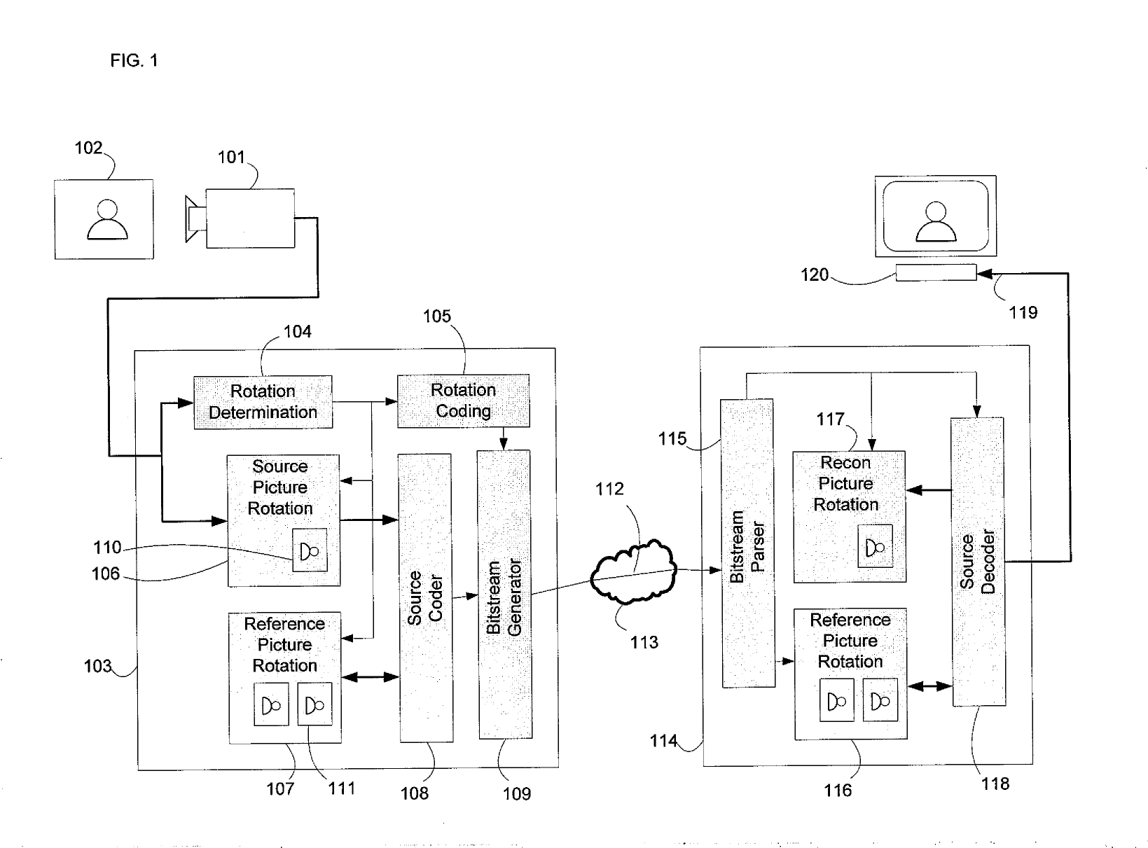

FIG. 1 shows, as an example for an application of the disclosed subject matter, the relevant parts of a video conferencing system. The line weights of data flows indicate the data volume; thick lines indicate the transmission of pixel data (high volume), where hairlines indicate the transmission of bitstream data or control information (low volume). A camera (101) captures a scene with an, for example, 4:3, aspect ratio format (102)—that is, horizontally there are 4/3 times the number of pixels as vertically. 076569.0360

Coupled to the camera (101) is a video encoder (103), which can include a rotation determination module (104), a rotation coding module (105), a source picture rotation module (106), a reference picture rotation module (107), a source coder (108) and a bitstream generator (109).

The rotation determination module (104) can be coupled to the input of the video encoder (103), and it can receive the uncompressed picture to be coded. It can be responsible for determining the optimal rotation of a source image and can forward this determination to a coupled rotation coding module (105), source picture rotation module (106) and reference picture rotation module (107). One criterion for this determination can be the coding efficiency achievable when coding a rotated or non-rotated source picture. There are many options for this determination, some of which are described later.

The rotation coding module (105) can use information received from the rotation determination module (104), and place this information in a bitstream representing the coded image, directly, or by informing the bitstream generator (109). In order to force a decoder (114) to use this information, the appropriate part of the bitstream should be decoded by the decoder; in other words, the information should be in a normative part of the bitstream. In HEVC, for example, one appropriate place for such information can be the slice header, and another can be the picture parameter set. Other normative parts of the bitstream can also be appropriate; this depends, for example, on the granularity to which picture orientation changes are applied (such as: group of picture, picture, rectangular region such as rectangular slice or tile, slice, or other elements of a bitstream), and the video coding standard in use.

The source picture rotation module (106) can be responsible to rotate the source picture based on, for example, the output of the rotation determination module (105), to which it can be coupled. Source picture rotation can consist of a straightforward two-dimensional rotational matrix transform, but can also advantageously include any pre-filter algorithms the video encoder wishes to employ. When the video encoder runs in software on a general purpose CPU, advantageously, the source picture rotation can use circuitry that can be available in Graphics Processing Units (GPUs) or other accelerators to so offload the CPU. The source picture rotation module can rotate, when appropriate, the source picture before the source coder (108) commences its operation (henceforth “batch” operation), or it can operate by rotating picture parts, or even single pixels, as and when required by the source coder (108) henceforth “on the fly” operation), or a mix of those two forms of operations. As, in many cases, all pixels of a source picture should be accessible by the source coder, in many architectures it can be advantageous to implement the rotation operation as a batch operation. Shown in FIG. 1 is an example of a source picture rotated by 90 degrees clockwise (110).

Similarly, the reference picture rotation module (107) can be responsible to rotate any reference pictures (111), or parts thereof (batch operation), or access unrotated reference picture memory and metadata taking rotation into account (on the fly operation), that are referenced by the source coder (108). When the current picture is coded without inter picture prediction (i.e. the picture is in intra mode), then the reference picture rotation module may not be involved in the coding process as no (rotated) reference picture is required for the coding process. When coding pictures using inter picture prediction, the reference picture rotation module (107) can be involved.

Especially when many reference pictures are in use, the computational overhead penalty for rotating not required reference pictures or reference picture parts can, depending on the architecture on which the encoder is running, outweigh the penalty for accessing individual pixels or (possibly small) parts of the reference picture(s) and metadata, thereby making an “on the fly” operations to reference picture data more efficient than batch operations.

Mixing forms between batch and on the fly operations are also possible: parts of the picture are rotated as a batch, the others are left unrotated.

It is also possible to access one or more reference pictures on the fly, whereas other reference picture(s) are batch processed. For example, when using long term memory reference picture selection, with a high probability, most pixels are predicted from the most recent reference picture. Therefore, that most recent reference picture can advantageously be rotated in a batch operation, whereas other reference pictures are accessed on the fly.

It should be clear from the description above that both “on the fly” rotation of (current or reference) pictures, picture parts, or pixels, and associated metadata, and rotation of all of a input or reference pictures have both utility, depending on the application. Insofar, when henceforth a rotated input or reference picture is mentioned, both pre-rotated and on-the-fly rotated pictures, picture parts, and pixels are possible.

The source coder (108) codes the current picture, taking into account the rotated or unrotated source and reference pictures (or parts thereof), as determined by, for example, the rotation determination module (104). It can create symbols, which can be fed into the bitstream generator (109).

The bitstream generator (109) can take the symbols created by the source coder (108) and the rotation coding module (105), and can create a bit stream, packet stream, NAL unit stream, or another form of self-contained representation (112) of the coded video stream (bitstream henceforth).

The bitstream (112) can be conveyed to a decoder (114). The specific transport mechanism is not relevant for the disclosure described, it can be, for example, transmission over a network (113), storage on a DVD or other medium and reading on the decoder site, and so forth. Shown is a real-time transmission over a network (113).

The decoder's task can be to reconstruct a video sequence similar or identical to the input video sequence (similar, because lossy compression can be involved). The decoder can include a bitstream parser (115), a reference picture rotation module (116), a reconstructed picture rotation module (117), and a source decoder (118).

The decoder's operation can follow the principles of video decoding with inter picture prediction, motion compensation, and transform coding of the residual, which is known by a person skilled in the art, with modifications as set forth below.

After reception, a bitstream parser (115) can identify and decode, among other symbols, rotation information that my have been previously, in the encoder, determined by the rotation determination module (104) and placed into the bitstream by the rotation information coding module (105) and or the bitstream generator (109).

The rotation information can be used by the reference picture rotation module (116) to rotate reference pictures, parts thereof, or individual pixel of reference picture(s), as needed to reconstruct the current picture. The rotation information can further be used by the reconstructed picture rotation module (117) to rotate the reconstructed picture after reconstruction, so to obtain the same picture orientation as the picture that was originally coded (before rotation) (102). The current reconstructed picture, after reconstruction is complete, can become a reference picture. In such a case, this new reference picture can, for example, be stored in rotated form (in conjunction with the rotation information), or it can be rotated according to the rotation information and stored in its original picture orientation. Similar mechanisms can apply also to parts of a picture, in case rotation is coded only for a part of the picture.

The source decoder (118) performs the reconstruction as usual, taking into account possibly rotated reference pictures.

The output of the source decoder (118) can be a video sequence (119) used by a rendering system (120), for example a graphics subsystem with attached computer monitor. This video sequence can be in the original orientation (in which case the reconstructed picture rotation module (117) is used to rotate the pictures for the rendering system (120)), or the final rotation can be left to a rendering system (120) (in which case the reconstructed picture rotation module is bypassed).

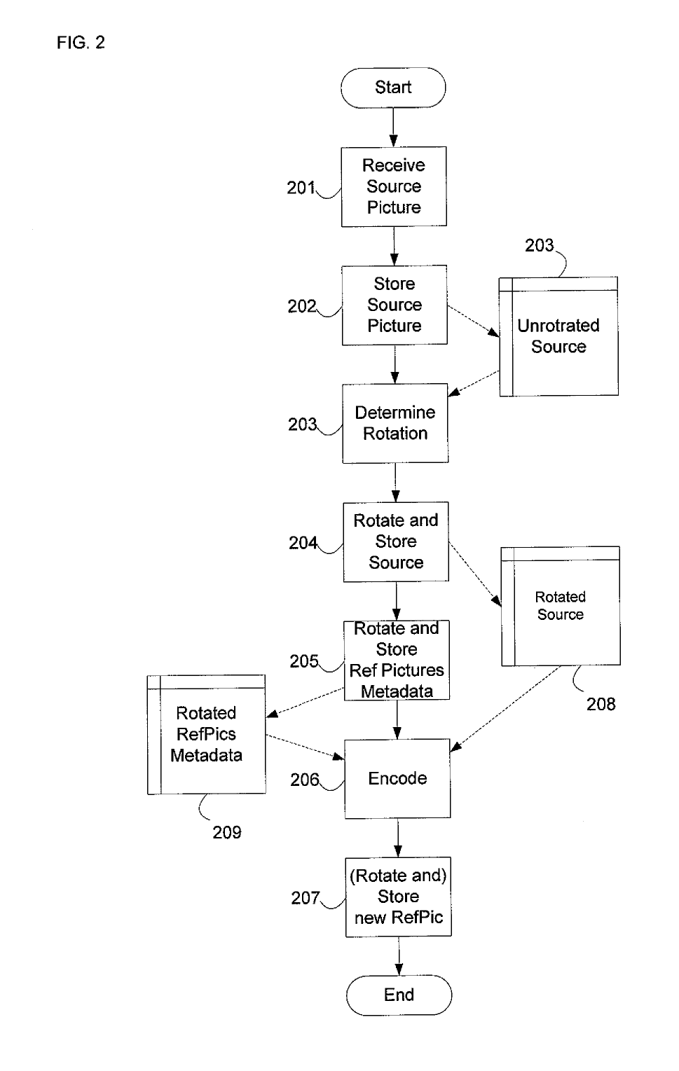

Described now is the operation of an exemplary encoder in more detail. In the following flowcharts (FIGS. 2-4), solid lines refer to control flow whereas dashed lines refer to data flow.

Referring to FIG. 2, in one embodiment, an encoder first receives (201) a to-be-coded source picture in a digital format, for example according to ITU-R Rec. BT 601.

In order to simplify the description, described is the operation on a single color plane, for example the luminance plane. A person skilled in the art can straightforwardly enhance the described mechanisms to support multiple colorplanes. Experiments have shown that it can be advantageous to handle different color planes independently when determining, coding, and using the rotation, but doing so can incur additional computational and/or implementation complexity, as well as additional overhead in the bitstream to signal the rotation for more than one color plane individually. It is equally possible to determine the rotation for all colorplanes by determining the optimal rotation for one or more colorplanes, and weighting the results, for example by pixel count, so to determine a rotation used for all colorplanes. It is also possible to handle colorplanes with similar properties similarly; for example, in 4:2:0 YCrCb coding, it can make sense to use one rotation for Y and another, independent (but possible identical) rotation for the two color planes CrCb.

In the same or another embodiment, the received picture can be stored (202) in a picture memory as a two-dimensional matrix, where the x and y dimensions of the matrix correspond with the x and y dimensions of the BT 601 digital camera signal (203). For example, if the camera sends a 720×480 picture, this picture can be stored in a matrix of 720×480 pixels. In other words, the picture can be stored without rotation.

In the same or another embodiment, next, the optimal rotation is determined (204).

The most efficient (in terms of coding efficiency), but also most computationally complex mechanism to determine the optimal rotation is to rotate the picture into all candidate rotation positions (for example: 0 degree and 90 degree clockwise), code the whole picture in this rotation format but with coding tool settings that can be otherwise identical, and count the number of bits generated. The rotation with the least number of bits at a similar quality is the optimal rotation. A person skilled in the art can readily devise a cost function that weights small differences in quality against small differences in bit rate. Such a rate optimization can multiply the computational complexity by the number of rotation candidates, which can be unreasonably high. However, an optimized encoder can easily recover many of the duplicated cycles by re-using information, such as motion vectors, generated during the encoding run of the first candidate rotation for the other candidate rotation runs.

It is also possible to determine the best rotation with high probability by heuristic mechanisms, which can be considerably less costly in terms of computational complexity.

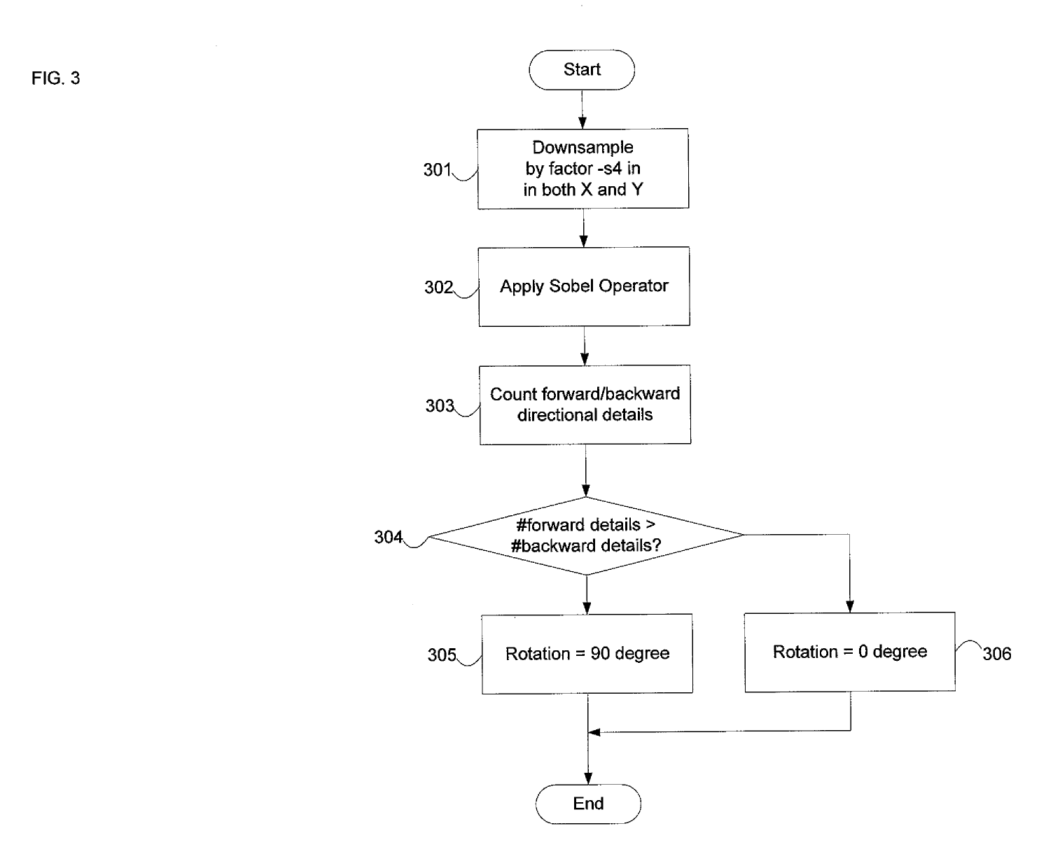

Briefly referring to FIG. 3, shown is a flow diagram for one exemplary mechanism to determine the optimal rotation between two candidates, 0 degree and 90 degree rotation. This mechanism has been shown to yield good results, at minimal computational complexity, when it is known that the picture to be coded will be coded in Intra mode, for example because it is an IDR picture. Many video coding applications regularly and frequently insert IDR pictures in video sequences as entry points for random access, and IDR pictures are particularly costly in terms of bits, so optimization through rotation for IDR pictures makes sense even in isolation (without optimization through rotation of non-IDR pictures).

In order to reduce the computation complexity, the input picture is down-sampled to 1/16 of the original resolution (¼ in each dimension) (301).

A Sobel operator is applied to each pixel of the down-sampled image to derive direction of details (302). A person skilled in image and video processing is readily aware of the nature of Sobel operators.

The number of forward diagonal details and the number of backward diagonal details (forward and backward being interpreted as scan order) are counted (303).

If there are more forward diagonal details than backward diagonal details (304), then rotate the input picture by 90 degrees (305), else, do not rotate (306).

In the same or another embodiment, rotation can be determined for a spatial part of a picture, such as a slice or a tile.

Referring back to FIG. 2, after the optimal rotation has been determined (203), the input picture can be coded in this rotation.

In the same or another embodiment, the input picture can be rotated and stored in a batch operation (204), using the determined rotation, and stored in a rotated source memory (208).

The rotation process for rotations of 90, 180, and 270 degrees is straightforward for anyone skilled in the art. If rotation candidates other than 90, 180, or 270 degrees are to be considered, filtering operations are typically required. Many such filters have been described in the academic literature. One possible filter candidate and rotation specification is the one described in the context of “picture warping” in ITU-T Rec. H.263 Annex P (Reference Picture Resampling). The use of rotation with degrees not evenly divisible by 90 can have the disadvantage that the filtering may not an exact reversible transformation, and the resulting possible loss of fidelity has to be taken into account when selecting a rotation not evenly divisible by 90 degrees. As before, the description continues to assume only rotation of 0 and 90 degrees (for illustration purposes only).

The rotation can be performed as a batch operation, on the fly, or as a mix of batch and on the fly operations.

As already pointed out, it is equally possible to handle the source picture rotation “on the fly”; which can be, whenever a pixel of the source picture is addressed in the source coding process later, that pixel can be addressed from an unrotated picture storage after a coordinate conversion.

In the same or another embodiment, rotation is performed for only a part of a picture, such as a slice or a tile.

Now the reference pictures and their associated metadata can be handled.

In the same or another embodiment, all reference pictures (or parts thereof) to be used by the encoding mechanism can be rotated and stored (205) in storage (209) (which can be as small as a single pixel when rotating on the fly.

Very similar considerations as for the rotation and storage of the input picture apply (especially with respect to batch and on-the-fly processing), with one exception: the possible need for rotation of reference picture metadata.

As already pointed out, the working draft of HEVC, at the time of writing, uses reference picture metadata in the form of motion vectors used during the reconstruction of the reference picture in question. While, as common in video compression and for efficiency reasons, motion vectors are conveyed in the bitstream for many pixels simultaneously (for a Prediction Unit (PU) in HEVC, or a block in older video compression standards), it is still the case that all pixels can have zero motion vectors (in case of an intra CU), one motion vector (in case of P prediction) or two motion vectors (in case of B prediction) associated with; it's the motion vector(s) that have been transmitted in the PU to which the pixel belongs.

The rotation of a vector is, once more, an operation known to those skilled in the art.

In the same or another embodiment, only parts of a reference picture, such as slices or tiles, are rotated.

At this point, source picture and reference pictures (or parts thereof, if only parts of the source picture are being rotated) are available in appropriately rotated form.

In the same or another embodiment, the source picture (or part thereof) is encoded (206). During the bit stream generation part of the encoding, rotation information is placed in an appropriate place of the bitstream. It was already pointed out that the appropriate place in the bitstream is dependent on the video coding standard in use. In the HEVC working draft at the time of writing, appropriate places can be the slice header, a picture parameter set, or a sequence parameter set. If parameter sets are in use, an appropriate parameter set indicating the correct rotation should be activated by referencing it in the slice header. A person familiar with HEVC (or other standards using the same high level syntax concepts, such as ITU-T Rec. H.264) are readily aware of the referencing mechanisms of parameter sets.

Depending on the number and nature of rotation candidates, fixed or variable length codes can be used. U.S. Provisional Patent Application 61/451,303 entitled “Render-Orientation Information In Video Bitstream”, includes some possible options.

The finalized bitstream can be made available to a decoder.

Depending on the coding mode, the reconstructed picture after encoding can be a new reference picture. This new reference picture can be rotated into the original orientation and stored fore future use as a reference picture (207). Alternatively, or in addition, the new reference picture can be stored in the form as used by the encode step (206), along with information indicating its rotation. The latter may have advantages if it is likely that more than one picture in a sequence are being processed in the same rotation.

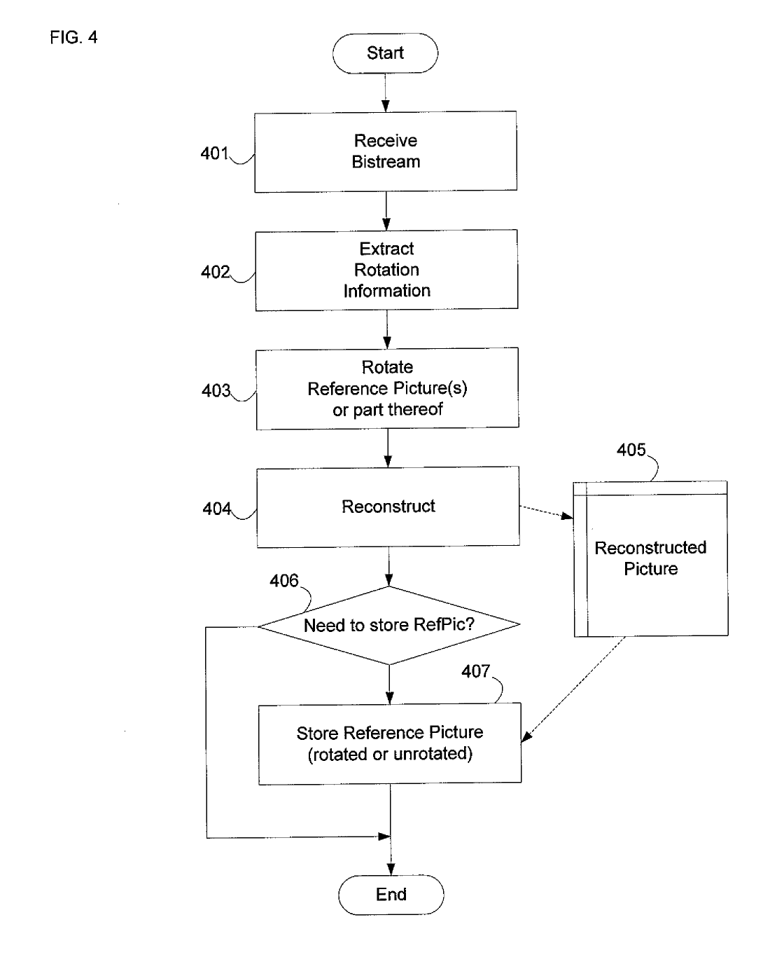

Referring to FIG. 4, a decoder operation using rotation is described next.

In an embodiment, a decoder receives (401) a bitstream including rotation information for a syntax structure such as a sequence of pictures, a picture, or parts of a picture (such as slice, tile). The possible location in the bitstream of such rotation information has already been discussed.

In the same or another embodiment, the decoder extracts rotation information, which can be located, for example in an activated picture parameter set, slice header, or similar syntax structure (402). When decoding syntax structure such as a picture or a slice, the decoder rotates reference picture(s) or parts thereof according to the extracted rotation information (403). The decoding can be performed in “batch” or “on the fly”.

In the same or another embodiment, as a first form of batch processing, the decoder stores the rotated reference picture(s) or parts thereof in a temporary memory, to be used for the decoding of this coded picture only. Doing so can be advantageous for general purpose CPU systems with at least two way associative writeback caches, as the number of cache misses during writeback is minimized.

In the same or another embodiment, as a second form of batch processing, the decoder stores the rotated reference picture (or parts thereof) in the reference picture memory, along with information about the rotation. This mechanism has advantages when it is likely that many adjacent coded pictures use the same rotation, as it can save cycles for the rotation operation. It also saves memory space.

In the same or another embodiment, as a third form of batch processing, the decoder can use caching techniques to store some (but possibly not all) rotations of reference pictures or parts thereof. This option may offer a good compromise between the previous two options advantages, but has higher implementation complexity.

In the same or another embodiment, a decoder can use “on the fly” access to unrotated reference picture memory, by coordinate-transforming the coordinates of the pixels in the reference picture required for reconstruction during the reconstruction process. In this case, the “reference picture rotation” step (403) can be empty in the sense that the operation is not performed before the reconstruction step (404) commences, but is part of the reconstruction process. In other words, instead of rotating the reference picture in a single operation, a part of the reference picture that can be as small as a single sample can be rotated whenever the reconstruction step (404) requires the use of this reference picture part.

In the same or another embodiment, one or more reference picture(s) (or parts thereof) are batch-rotated as discussed above, and one or more are converted “on the fly”. For example, when long term memory reference picture selection is in use, for most video content, referenced are overwhelmingly pixels from the most recent reference picture; but some pixels may also be referenced from older reference pictures. It can be a good compromise to batch rotate the most recent reference picture, and use “on the fly” rotation for older reference pictures.

In the same or another embodiment, reconstruction is performed as usual, except that batch=rotated reference picture(s) (or parts thereof), that were stored in the reference picture rotation step (402) are being used.

In the same or another embodiment, reconstruction (404) is performed as usual, except that on the fly rotation of one or more pixels is performed.

The output of the reconstruction process (404) is a reconstructed picture (405), that, in many cases, can be used as a reference picture, and also can be used for rendering. In HEVC and other modern video coding schemes, the reconstruction mechanism can also generated associated metadata that can be required for future decoding of the reconstructed picture is used as a reference picture.

In the same or another embodiment, the decoder determines whether a given reconstructed picture (or parts thereof) should be stored as a reference picture (406). The nature of this decision process depends on the video coding standard involved, and is known to those skilled in the art.

In the same or another embodiment, if the reconstructed picture needs to be stored as a reference picture, it is rotated into the original rotation (i.e. the inverse of the reference picture rotation of the reference picture (or parts thereof) during reconstruction is applied), and it is stored (407) in unrotated form.

In the same or another embodiment, the reconstructed picture is stored as a reference picture in rotated form (407) along with information indicating the rotation.

In either case, it can be possible that the whole reference picture to be stored is rotated, or only parts thereof (such as a tile, slice, . . . )

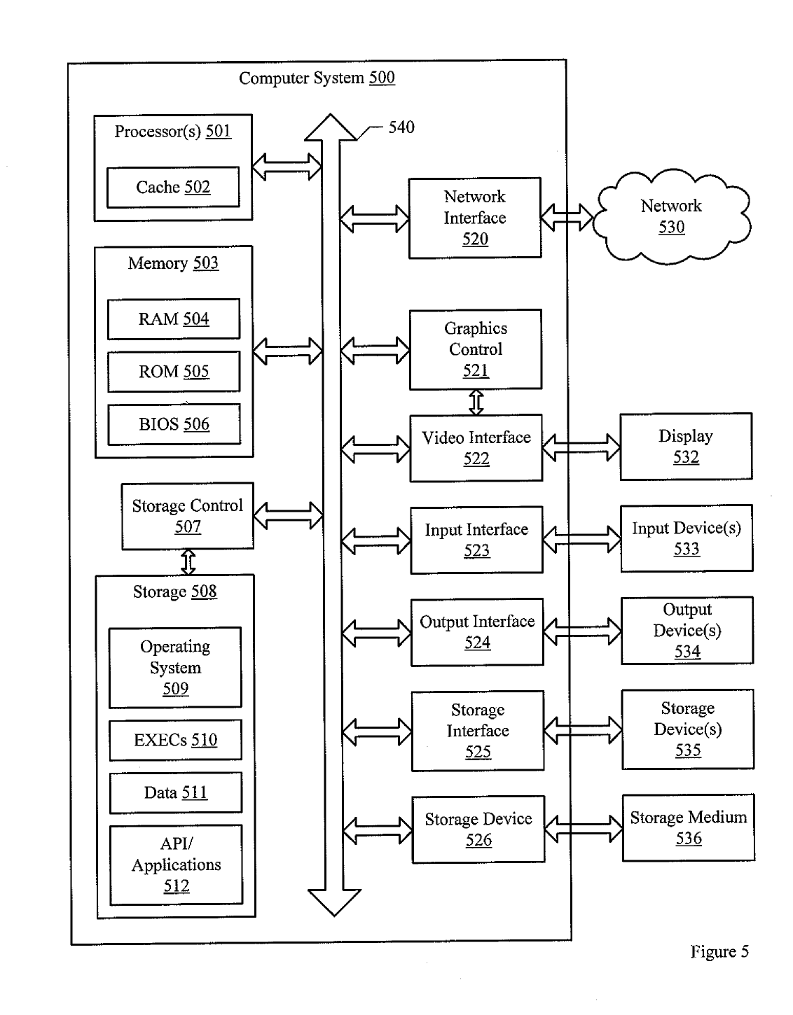

The methods for picture rotation described above can be implemented as computer software using computer-readable instructions and physically stored in computer-readable medium. The computer software can be encoded using any suitable computer languages. The software instructions can be executed on various types of computers. For example, FIG. 5 illustrates a computer system 500 suitable for implementing embodiments of the present disclosure.

The components shown in FIG. 5 for computer system 500 are exemplary in nature and are not intended to suggest any limitation as to the scope of use or functionality of the computer software implementing embodiments of the present disclosure. Neither should the configuration of components be interpreted as having any dependency or requirement relating to any one or combination of components illustrated in the exemplary embodiment of a computer system. Computer system 500 can have many physical forms including an integrated circuit, a printed circuit board, a small handheld device (such as a mobile telephone or PDA), a personal computer or a super computer.

Computer system 500 includes a display 532, one or more input devices 533 (e.g., keypad, keyboard, mouse, stylus, etc.), one or more output devices 534 (e.g., speaker), one or more storage devices 535, various types of storage medium 536.

The system bus 540 link a wide variety of subsystems. As understood by those skilled in the art, a “bus” refers to a plurality of digital signal lines serving a common function. The system bus 540 can be any of several types of bus structures including a memory bus, a peripheral bus, and a local bus using any of a variety of bus architectures. By way of example and not limitation, such architectures include the Industry Standard Architecture (ISA) bus, Enhanced ISA (EISA) bus, the Micro Channel Architecture (MCA) bus, the Video Electronics Standards Association local (VLB) bus, the Peripheral Component Interconnect (PCI) bus, the PCI-Express bus (PCI-X), and the Accelerated Graphics Port (AGP) bus.

Processor(s) 501 (also referred to as central processing units, or CPUs) optionally contain a cache memory unit 502 for temporary local storage of instructions, data, or computer addresses. Processor(s) 501 are coupled to storage devices including memory 503. Memory 503 includes random access memory {RAM) 504 and read-only memory (ROM) 505. As is well known in the art, ROM 505 acts to transfer data and instructions uni-directionally to the processor(s) 501, and RAM 504 is used typically to transfer data and instructions in a bi-directional manner. Both of these types of memories can include any suitable of the computer-readable media described below.

A fixed storage 508 is also coupled bi-directionally to the processor(s) 501, optionally via a storage control unit 507. It provides additional data storage capacity and can also include any of the computer-readable media described below. Storage 508 can be used to store operating system 509, EXECs 510, application programs 512, data 511 and the like and is typically a secondary storage medium {such as a hard disk) that is slower than primary storage. It should be appreciated that the information retained within storage 508, can, in appropriate cases, be incorporated in standard fashion as virtual memory in memory 503.

Processor(s) 501 is also coupled to a variety of interfaces such as graphics control 521, video interface 522, input interface 523, output interface 524, storage interface 525, and these interfaces in turn are coupled to the appropriate devices. In general, an input/output device can be any of: video displays, track balls, mice, keyboards, microphones, touch-sensitive displays, transducer card readers, magnetic or paper tape readers, tablets, styluses, voice or handwriting recognizers, biometrics readers, or other computers. Processor(s) 501 can be coupled to another computer or telecommunications network 530 using network interface 520. With such a network interface 520, it is contemplated that the CPU 501 might receive information from the network 530, or might output information to the network in the course of performing the above-described method. Furthermore, method embodiments of the present disclosure can execute solely upon CPU 501 or can execute over a network 530 such as the Internet in conjunction with a remote CPU 501 that shares a portion of the processing.

According to various embodiments, when in a network environment, i.e., when computer system 500 is connected to network 530, computer system 500 can communicate with other devices that are also connected to network 530. Communications can be sent to and from computer system 500 via network interface 520. For example, incoming communications, such as a request or a response from another device, in the form of one or more packets, can be received from network 530 at network interface 520 and stored in selected sections in memory 503 for processing. Outgoing communications, such as a request or a response to another device, again in the form of one or more packets, can also be stored in selected sections in memory 503 and sent out to network 530 at network interface 520. Processor(s) 501 can access these communication packets stored in memory 503 for processing.

In addition, embodiments of the present disclosure further relate to computer storage products with a computer-readable medium that have computer code thereon for performing various computer-implemented operations. The media and computer code can be those specially designed and constructed for the purposes of the present disclosure, or they can be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as optical disks; and hardware devices that are specially configured to store and execute program code, such as application-specific integrated circuits (ASICs), programmable logic devices (PLDs) and ROM and RAM devices. Examples of computer code include machine code, such as produced by a compiler, and files containing higher-level code that are executed by a computer using an interpreter.

As an example and not by way of limitation, the computer system having architecture 500 can provide functionality as a result of processor(s) 501 executing software embodied in one or more tangible, computer-readable media, such as memory 503. The software implementing various embodiments of the present disclosure can be stored in memory 503 and executed by processor(s) 501. A computer-readable medium can include one or more memory devices, according to particular needs. Memory 503 can read the software from one or more other computer-readable media, such as mass storage device(s) 535 or from one or more other sources via communication interface. The software can cause processor(s) 501 to execute particular processes or particular parts of particular processes described herein, including defining data structures stored in memory 503 and modifying such data structures according to the processes defined by the software. In addition or as an alternative, the computer system can provide functionality as a result of logic hardwired or otherwise embodied in a circuit, which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

While this disclosure has described several exemplary embodiments, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

We claim:

1. A method for decoding a picture embedded in a coded video sequence using a reference picture, comprising:
receiving at least a part of the coded video sequence;
decoding the at least a part of the coded video sequence to determine a rotation of the embedded picture;
rotating at least a part of the reference picture according to the determined rotation; and
using the at least a part of a rotated reference picture to construct a reconstructed picture corresponding to the embedded picture.

2. The method of claim 1, wherein the part of a reference picture includes metadata.

3. The method of claim 1, wherein the rotation is applied to at least one full reference picture.

4. The method of claim 1, wherein the rotation is applied to at least one rectangular region of at least one reference picture.

5. The method of claim 5, including step of rotating the at least one reconstructed sample to an original rotation.

6. The method of claim 1, including a step of storing the at least one reconstructed sample as a reference picture or part thereof.

7. A method for decoding a picture embedded in a coded video sequence, comprising:
receiving at least a part of the coded video sequence;
decoding the at least a part of the coded video sequence to determine a rotation of the embedded picture; and
storing at least one sample of a reconstructed picture as a reference picture or part thereof, wherein
the at least one sample is either rotated to an original orientation before storing, or
the at least one sample is stored with associated information indicative of the rotation.

8. A method for encoding, comprising:
receiving a source picture;
determining a rotation of the source picture;
rotating at least one sample of the source picture according to the determined rotation;
encoding the at least one sample; and
storing the at least one sample as a reference picture or part thereof.

9. The method of claim 8 further comprising:
rotating at least one sample of at least one reference picture according to the determined rotation.

10. The method of claim 9, wherein at least one of the at least one sample has associated metadata.

11. A video encoder, comprising:
a rotation determination module;
a source picture rotation module for rotating the source picture, the source picture rotation module being coupled to the rotation determination module;
a source encoder for coding the source picture, the source encoder being coupled to the source picture rotation module; and
a bitstream encoder; the bitstream encoder being coupled to the source encoder;
wherein the rotation determination module is configured to determine a rotation of a source picture beneficial for coding efficiency.

12. The video encoder of claim 11, further comprising:
a reference picture rotation module, coupled to the rotation determination module and configured to rotate at least one sample of at least one reference picture according to information received from the rotation determination module.

13. The video encoder of claim 11, wherein the bitstream encoder is configured to generate a bitstream containing a rotation information.

14. A video decoder, comprising:
a bitstream parser configured to determine rotation information of a picture embedded in a coded video sequence;
a reference picture rotation module coupled to the bitstream parser and configured to rotate at least one sample of at least one reference picture according to the rotation information received from the bitstream parser.

15. The video decoder according to claim 14, further comprising:
a reconstructed picture rotation module configured to rotate at least one pixel of a reconstructed picture.

16. A video decoder, comprising:
a bitstream parser configured to determine rotation information of an embedded picture; and
a reference picture rotation module, configured to store at least one sample of a reconstructed picture as a reference picture or part thereof,
wherein
the at least one sample is either rotated to an original orientation before storing, or
the at least one sample is stored with associated information indicative of the rotation.
